(19) United States
(12) Patent Application Publication
(10) Pub. No.: US 2003/0185684 A1
(43) Pub. Date: Oct. 2, 2003

(54) Detachable snap-fit hub assembly for electric fan

(75) Inventor: Qun-Liang Zhong, Xinhui City (CN)

Correspondence Address: MERCHANT & GOULD PC, P.O. BOX 2903, MINNEAPOLIS, MN, 55402-0903, US

(73) Assignee: Bestpro Ltd., Road Town (VG)

(21) Appl. No.: 10/302,602

(22) Filed: Nov. 21, 2002

(30) Foreign Application Priority Data
Dec. 30, 2001 (CN) 01280071.6

(51) Int. Cl. F03B 3/12

(52) U.S. Cl. 416/210 R

(57) ABSTRACT

A detachable snap-fit hub assembly for electric fan, comprising a first member connecting to a motor and a second member connecting to fan blades, wherein said first member and second member are, respectively, provided with one or more sections of slide grooves and corresponding wedge protrusions, such that when said slide grooves fit tight with said wedge protrusions, said two members are accurately assembled together. Since said two members can be detached and assembled in a snap-fit manner, both transport of fans and assembly thereof are made simple and easy, and a high precision of fan assembly can also be ensured.

### FIELD OF INVENTION

The present invention relates to a snap-fit hub assembly for electric fan, in particular, a snap-fit hub assembly meant for a ceiling fan.

### BACKGROUND OF INVENTION

Ornamental ceiling fans in the prior art (see FIG. 3) are usually provided with a blade hub (FIGS. 1 and 2), normally either cast from zinc alloy or punched into shape from a steel sheet; the hub functions to connect the blades onto the motor rotor. At the same time, the said hub is also an ornamental member. Usually, when packing, the said hub member is packed separately from the motor and the blades, and it is up to the customer to assemble after unpacking. Suppose an electric fan has an average of 4-6 blades and five screws are needed to fix one blade to the motor rotor of the electric fan, then a total of 30 screws will have to be fitted in order to connect all the blades onto the motor rotor, which means a huge amount of work, indeed. This results, particularly in certain advanced countries and regions, in that the assembling cost for employing a licensed technician amounts to over 50% of the price of the electric fan. What is more important is that in different regions there are differences in the assembling techniques, as well as in the sense of responsibility, which in turn often leads to a failure of dynamic balance operation of the fan, and such a balance operation is normally an object of the manufacturer's design. Therefore, various technical plans have so far been considered of an accurate, quicker, safer and simpler assembling approach of the fan blades.

A plan first adopted related to a foldable hub structure, where the blades, after having been fixed onto the motor, are folded as shown in FIG. 4 before packing. Upon unpacking, the customer just unpacks them into the horizontal position. The deficiency of that plan is that, though a spring is provided in the folding part, locating is difficult, which results in that the varying air resistance may cause the blades to vibrate up and down, bringing about also a noise. In addition, the packing volume was largely increased, and thus, also the transport cost.

Another plan was to divide the hub structure in FIG. 2 into two casting members, as shown in FIG. 5. Member A is fixed tight to the motor rotor while Member B, to the blades. The plan according to FIG. 5 is to provide, in a direction vertical to the hub axis, a male and female structure (the so-called ‘key hole structure’); to assemble, just insert Member B into Member A, turn by 90° and pull back to lock. In order to prevent looseness between the two members, a complicated elastic structural member ‘a’ is provided. While assembling, first position Member B into Member A's chamber, turn by 90° and then let go; by means of the pressure of a coil spring in the said structural member, Member B will be duly pressed by 90° into position. The shortcoming of this plan is that operation is not simple and structure is complicated; and the appearance of the structure is not pleasant to the eye for ornamental purposes. Moreover, the structure is limited by the size of the hub, so that the length of travel inside the structure is at most 4-6 mm, which can hardly ensure the coaxality of Members A and B when fitted. If five blades point to different directions, then the electric fan will be running in vibration, which is surely something a customer could not accept. In addition, such structure can only be located in the middle of the hub, but not to any other part of it; neither can such structure be made in a stamped member.

### SUMMARY OF INVENTION

The object of the present invention is to overcome the above shortcomings by providing an improved structure, namely, a detachable snap-fit hub assembly, so as to maintain as much as possible the original appearance of the members, and to realize a simple, reliable, accurate and safe assembling procedure.

According to the present invention, there is provided a hub assembly having a number of radially extending short arms and in each of the said short arms there are provided one or more slide grooves arranged in a direction parallel to the arm axis. Said slide grooves match corresponding wedge protrusions in another member connecting to a blade. Owing to the sufficient length of the slide groove(s) (the long-travel-length principle), coaxality of the blades and the hub arms can be ensured, so that the fan can run in a dynamic balance operation as is required by the manufacturer's design standard.

More specifically, the hub assembly according to the present invention comprises a Member C connected to the motor rotor, a Member D connected to the blades, and screws and nuts, wherein Member C is provided with one or more sections of slide groove(s) ‘h’ arranged parallel to its axis, and Member D is provided with one or more sections of wedge protrusion(s) ‘f’ to match the said slide groove(s) ‘h’. When Member D and Member C fit together in the vertical direction, sliding in the horizontal direction is still possible. Pull Member D until the said slide groove(s) ‘h’ fit tight with the said protrusion(s) ‘f’; in this way, Members D and C are fitted together accurately.

Obviously, the same function can be reached if the said slide grooves ‘h’ change places with the said protrusions ‘f’, since the assembling result will remain the same. Moreover, such detachable snap-fit structure can be located in any part of the hub arm, while the same assembling result is obtained.

Members C and D are normally castings from an alloy (for example, Zn—Al alloy), or pieces stamped from sheet material (such as steel sheet). As for the slide grooves ‘h’ and wedge protrusions ‘f’, they can be of various cross section shapes, including rectangular, circular, or dovetail shape.

Preferably, a locating spring leaf ‘e’ is provided, so as to help towards locating and increasing the assembling precision.

The advantage of the present invention is to apply the principle of long-travel-length slide groove to the detachable assembling structure, thus ensuring good assembling precision; another advantage is to realize a simple assembling procedure, which ensures reliability, accurateness, and safety, while the original appearance of a fan is well maintained for ornamental purposes.

### BRIEF DESCRIPTION OF THE DRAWINGS

The above objects and advantages of the present invention will become clear by the following description of a preferred embodiment of the present invention with reference to the accompanying drawings, wherein:

FIG. 1 is a perspective view of an alloy hub structure in the prior art;

FIG. 2 is a perspective view of a hub structure formed by stamping from steel sheet;

FIG. 3 is an illustration of a foldable-blade ceiling fan in the prior art;

FIG. 4 is an illustration of the fan in FIG. 3 with the blades folded;

FIG. 5 is an illustration of an electric fan with a detachable hub assembly in the prior art;

FIG. 6 is an illustration of the detachable hub assembly according to the present invention, provided with a two-section dovetail groove structure;

FIG. 7 shows the d-d section in FIG. 6, d1 being a rectangular cross section and d2, a circular cross section shape;

FIG. 8 shows an auxiliary locating spring leaf ‘e’ and its function;

FIG. 9 shows the assembly procedure of the detachable hub assembly according to the present invention;

FIG. 10 shows the hub assembly of the present invention as having been duly assembled;

FIG. 11 shows another embodiment according to the present invention;

FIG. 12 shows the assembly as per FIG. 11;

FIG. 13 shows a third embodiment according to the present invention;

FIG. 14 shows a forth embodiment according to the present invention wherein the said assembly is a punched member;

FIG. 15 is a fifth embodiment according to the present invention where the said detachable structure of the hub assembly is punched into shape in the middle of the same; and

FIG. 16 shows the K-K section in FIG. 15.

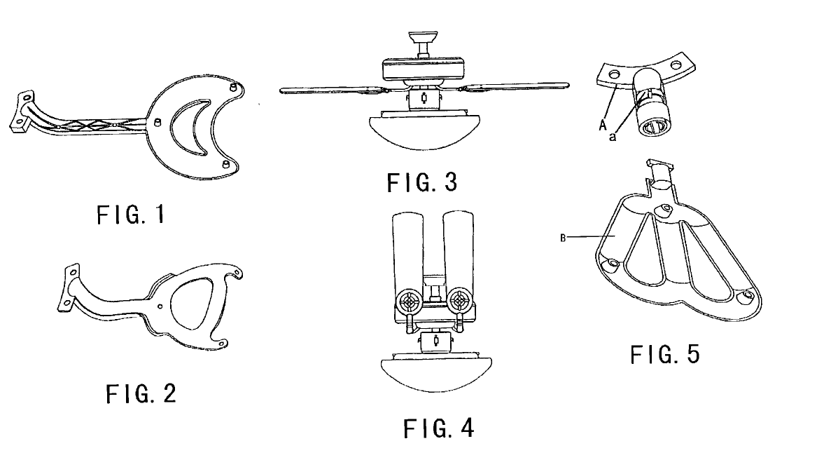

### DETAILED DESCRIPTION OF PREFERRED EMBODIMENT

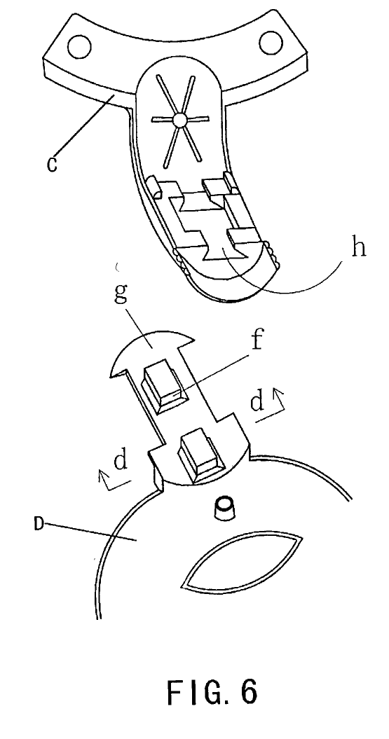

The detachable snap-fit hub assembly according to the present invention comprises, as shown in FIG. 6-10, a Member C and a Member D (in the present embodiment, both Members C and D are castings), said Member C being provided with the typical two-section dovetail groove structure having two slide grooves ‘h’ to match corresponding wedge protrusions ‘f’ in Member D (an inverted taper groove used in case of a one-section groove structure can be regarded as a variation of the slide groove); Member D having a head ‘g’ which further comprises, in the end side or the lower part thereof, a boss just to butt a corresponding hog on said Member C for position limiting. If there were not such a strong enough boss structure, Member D would slide off from Member C. Of course, the same function could be reached if the end of the dovetail groove were closed; but that would require high technology, particularly in case of a taper matching. The structure according to the present invention is particularly advantageous in that when there is a large burden and the length of the hub assembly permits, a three-section groove structure or a structure of more than three sections can also be adopted, so as to increase the safety coefficient.

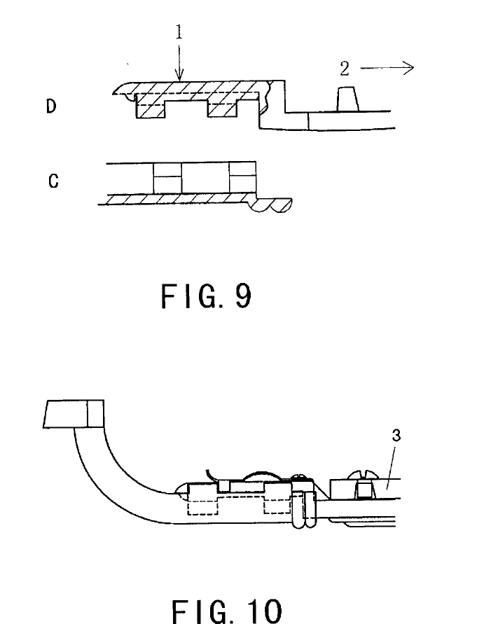

The arrows 1 and 2 in FIG. 9 illustrate the assembling steps of the detachable snap-fit hub assembly for electric fan according to the present invention. First, Member D is to fit with Member C in the vertical direction shown by Arrow 1; then a horizontal sliding will follow in the direction shown by Arrow 2, until the wedge protrusion ‘f’ butts tight with the slide groove ‘h’. In this way, Member C and Member D can be assembled together in an accurate manner. FIG. 10 shows the detachable snap-fit hub assembly for electric fan as properly assembled, wherein 3 is a blade. As seen, the assembly as a whole is good-looking in appearance; and the problem of assembling quality of electric fans caused by difference in assembling techniques in different regions is done away with.

Preferably, a spring leaf ‘e’, as shown in FIG. 8, is added to function as a safety device, to prevent Member D from sliding forward off from Member C. When de-assembling, just pull up the spring leaf with a finger (or insert in a piece of wood), Member D will then slide off forwardly. A similar locating spring can also be provided in other part of Member D. In order to eliminate the slight gap influence, a spring sheet can be provided at the bottom of the slide groove.

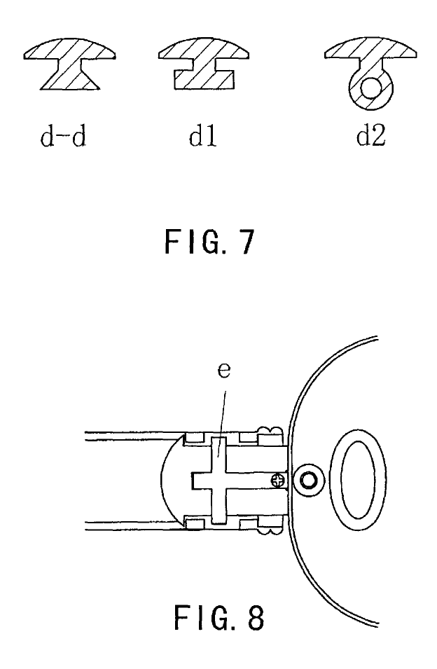

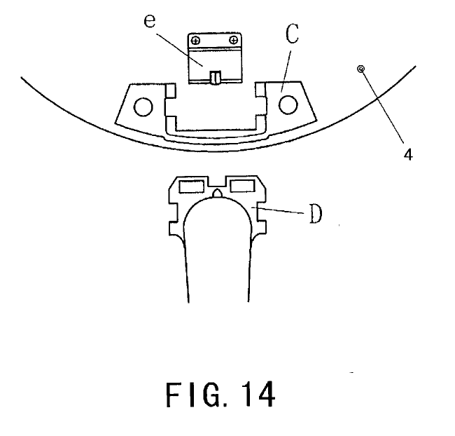

Slide groove ‘h’ and wedge protrusion ‘f’ can be of different types having different cross sections, including rectangular, circular, dovetail-shaped, etc. In the present embodiment, as shown by the d-d section in FIG. 7, a dovetail-shaped wedge is adopted. Sections d1 and d2 in FIG. 7 represent two other shapes, namely, a rectangular wedge and a circular wedge, all well matching with corresponding slide grooves in Member C. They two can be listed as two other embodiments of the present invention. A circular cross section d2, similar in shape to the semicircle structure in Member C, will, however, result in saving of material while the same bending strength is ensured. And if formed through punching from hardware, a simpler shape can be obtained, as shown in FIG. 14.

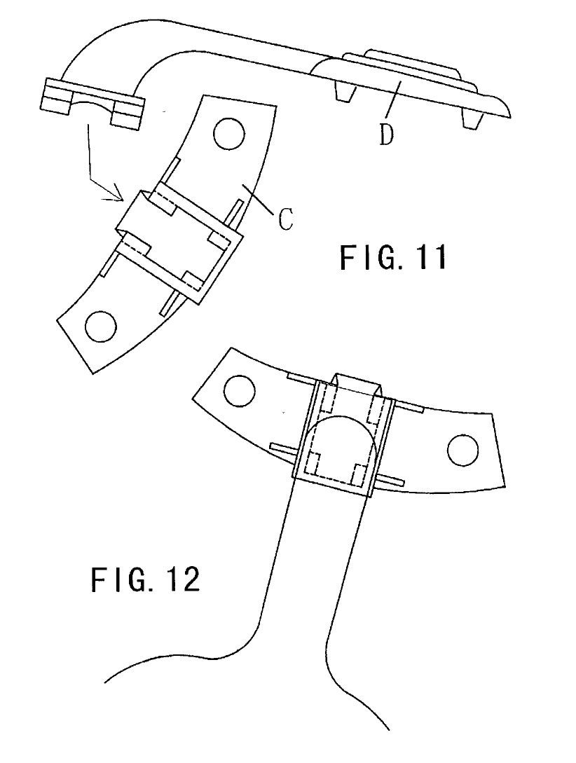

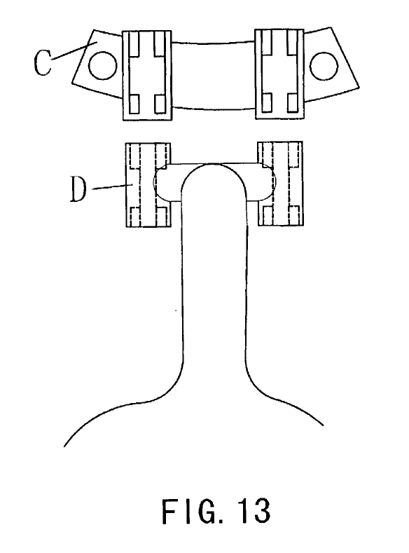

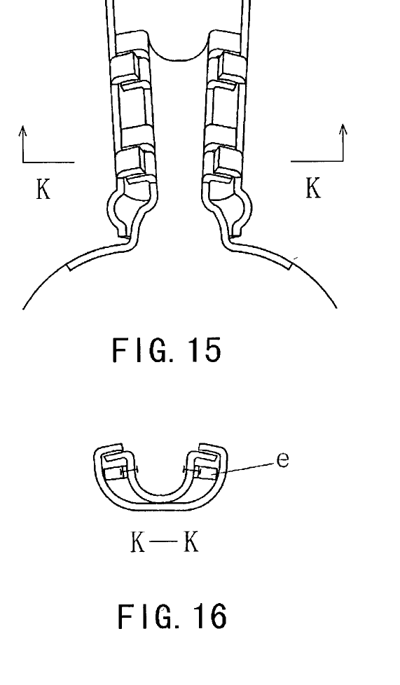

It should be noted that if the snap-fit structures in Members C and D, namely, the slide groove ‘h’ and the wedge protrusion ‘f’, change places, the same function can be reached, since no change would occur to the snap-fit effect. Moreover, the above-described snap-fit structures can be arranged in other part of the hub assembly to reach the same function. FIGS. 11-13 show such other embodiments of the present invention, wherein FIGS. 11 and 12 show the said snap-fit structures located at the root of the hub assembly. FIG. 13 shows another embodiment, wherein two sets of snap-fit structures are provided for heavier burden. FIGS. 14 and 15 show embodiments of the present invention wherein the snap-fit structures are formed through punching from ordinary steel sheets; 4 representing the motor case. FIG. 16 shows the K-K section in FIG. 15.

It is apparent from the above detailed description of the present invention that the various embodiments are merely examples helping to understand the present invention, the structures therein being in no sense any limitation to the scope of the present invention. A number of variants and/or improvements based on the principle of the present invention can be made by an ordinary technician in the line. For example, besides alloy metals or steel sheets, the hub assembly of the present invention can also be made from other metals or even plastics. Similarly, Members C and D can also be made from different materials. As an example, Member C can be an alloy casting while Member D can be made from hardware, so long as they match in shape. In addition, instead of the spring leaf in the present invention, other kinds of springs can be used to reach the same function, depending on the different environment of use and/or need. It is, therefore, to be understood that various changes and minor details of construction within the scope of the claims, may be resorted to without departing from the spirit of the present invention, or sacrificing any of the advantages thereof.

I claim:

1. A detachable snap-fit hub assembly for electric fan according to the present invention having a number of radially extending short arms, comprising:
a first member, as represented by each of the said short arms, connecting to a motor rotor,
a second member connecting to a fan blade,
as well as a number of screws and nuts,
wherein said first member is provided with one or more sections of slide grooves, arranged parallel to the axis of said short arm, said second member having corresponding wedge protrusions to match the said slide grooves, such that when the said wedge protrusions are fitted into the said slide grooves, said first and second members are accurately assembled.

2. A snap-fit hub assembly as claimed in claim 1, wherein said slide grooves in said first member have changed places with said wedge protrusions in said second member.

3. A snap-fit hub assembly as claimed in claims 1 or 2, wherein said first member and second member are made from zinc-based alloy through casting.

4. A snap-fit hub assembly as claimed in claims 1 or 2, wherein said first and second members are made from steel sheets through punching.

5. A snap-fit hub assembly as claimed in claims 1 or 2, wherein said slide grooves and said wedge protrusions are located in the middle of said hub assembly.

6. A snap-fit hub assembly as claimed in claims 1 or 2, wherein said slide grooves and said wedge protrusions are located at the root of said hub assembly.

7. A snap-fit hub assembly as claimed in claims 1 or 2, wherein said wedge protrusions have a rectangular cross section.

8. A snap-fit hub assembly as claimed in claims 1 or 2, wherein said wedge protrusions have a circular cross section.

9. A snap-fit hub assembly as claimed in claims 1 or 2, wherein said wedge protrusions have a dovetail cross section
